(19) United States
(12) Patent Application Publication
(10) Pub. No.: US 2015/0036982 A1
(43) Pub. Date: Feb. 5, 2015

(54) TAPER STRAIN RELIEF BOOT FOR FERRULE FLEX CONNECTORS

(71) Applicant: ADC Telecommunications, Inc., Berwyn, PA (US)

(72) Inventors: Ponharith Nhep, Savage, MN (US); Steven C. Zimmel, Minneapolis, MN (US)

(21) Appl. No.: 14/449,413

(22) Filed: Aug. 1, 2014

Related U.S. Application Data
(60) Provisional application No. 61/861,831, filed on Aug. 2, 2013.

(51) Int. Cl. G02B 6/44

(52) U.S. Cl. CPC G02B 6/4477
USPC 385/86

(57) ABSTRACT

A fiber optic connector including a connector body including a distal end and a proximal end. The distal end forming a plug end of the connector body and an optical fiber routed through the connector body. The optical fiber having an end face accessible at the plug end of the connector body and a strain relief boot that mounts at the proximal end of the connector body. The strain relief boot defines a longitudinal axis that extends through the strain relief boot between distal and proximal ends of the strain relief boot. The strain relief boot includes an interior surface that defines a fiber passage through which the optical fiber is routed; the fiber passage extends along the longitudinal axis of the boot. The strain relief boot includes an exterior surface that defines a tapered exterior shape that tapers inwardly toward the longitudinal axis as the tapered exterior shape extends in a proximal direction along the longitudinal axis. The interior surface of the strain relief boot defines a flared interior shape co-extensive along the longitudinal axis with at least a portion of the tapered exterior shape. The flared interior shape of the fiber passage flaring outwardly from the longitudinal axis as the flared interior shape extends in the proximal direction along the longitudinal axis.

### CROSS-REFERENCE TO RELATED APPLICATION

The present patent application claims the benefit of U.S. Provisional Patent Application Ser. No. 61/861,831, filed Aug. 2, 2013, which application is hereby incorporated by reference in its entirety.

### TECHNICAL FIELD

The present disclosure relates generally to optical fiber communication systems. More particularly, the present disclosure relates to strain relief boots of fiber optic connectors having a taper configuration inside the boot for use in optical fiber communication systems.

### BACKGROUND

Fiber optic communication systems are becoming prevalent in part because service providers want to deliver high bandwidth communication capabilities (e.g., data and voice) to customers. Fiber optic communication systems employ a network of fiber optic cables to transmit large volumes of data and voice signals over relatively long distances. Optical fiber connectors are an important part of most fiber optic communication systems. Fiber optic connectors allow two optical fibers to be quickly optically connected without requiring a splice. Fiber optic connectors can be used to optically interconnect two lengths of optical fiber. Fiber optic connectors can also be used to interconnect lengths of optical fiber to passive and active equipment.

A typical fiber optic connector includes a ferrule assembly supported at a distal end of a connector housing. A spring is used to bias the ferrule assembly in a distal direction relative to the connector housing. The ferrule functions to support an end portion of at least one optical fiber (in the case of a multi-fiber ferrule, the ends of multiple fibers are supported). The ferrule has a distal end face at which a polished end of the optical fiber is located. When two fiber optic connectors are interconnected, the distal end faces of the ferrules abut one another and the ferrules are forced proximally relative to their respective connector housings against the bias of their respective springs. With the fiber optic connectors connected, their respective optical fibers are coaxially aligned such that the end faces of the optical fibers directly oppose one another. In this way, an optical signal can be transmitted from optical fiber to optical fiber through the aligned end faces of the optical fibers. For many fiber optic connector styles, alignment between two fiber optic connectors is provided through the use of an intermediate fiber optic adapter.

Fiber optic connectors often include strain relief boots mounted at proximal ends of the connector housings. Strain relief boots are designed to prevent the optical fibers within the fiber optic cables secured to the fiber optic connectors from bending to radii less than the minimum bend radii of the optical fibers when side loads are applied to the fiber optic cables. Example strain relief boot configurations are disclosed in United States Patent Application Publication Nos. US 2011/0002586 and US 2010/0254663; and are also disclosed in U.S. Pat. Nos. 7,677,812; 7,147,385; 5,915,056; 5,390,272; and 5,261,019.

### SUMMARY

One aspect of the present disclosure relates to a fiber optic connector including

a connector body including a distal end and a proximal end. The distal end forming a plug end of the connector body and an optical fiber routed through the connector body. The optical fiber having an end face accessible at the plug end of the connector body and a strain relief boot that mounts at the proximal end of the connector body. The strain relief boot defines a longitudinal axis that extends through the strain relief boot between distal and proximal ends of the strain relief boot. The strain relief boot includes an interior surface that defines a fiber passage through which the optical fiber is routed; the fiber passage extends along the longitudinal axis of the boot. The strain relief boot includes an exterior surface that defines a tapered exterior shape that tapers inwardly toward the longitudinal axis as the tapered exterior shape extends in a proximal direction along the longitudinal axis. The interior surface of the strain relief boot defines a flared interior shape co-extensive along the longitudinal axis with at least a portion of the tapered exterior shape. The flared interior shape of the fiber passage flaring outwardly from the longitudinal axis as the flared interior shape extends in the proximal direction along the longitudinal axis.

A variety of additional aspects will be set forth in the description that follows. The aspects relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 is a perspective, exploded view of a fiber optic connector in accordance with the principles of the present disclosure;

FIG. 2 is a cross-sectional view that longitudinally bisects the fiber optic connector of FIG. 1;

FIG. 3 is a perspective view showing a first end of a strain relief boot of the fiber optic connector of FIG. 1;

FIG. 4 is a perspective view showing a second end of the strain relief boot of FIG. 3;

FIG. 5 is a cross-sectional view that longitudinally bisects the strain relief boot of FIGS. 3 and 4;

FIG. 6 is a perspective, exploded view of another fiber optic connector in accordance with the principles of the present disclosure;

FIG. 7 is a cross-sectional view that longitudinally bisects the fiber optic connector of FIG. 6;

FIG. 8 is a perspective view showing a first end of a strain relief boot of the fiber optic connector of FIG. 6;

FIG. 9 is a perspective view showing a second end of the strain relief boot of FIG. 8; and

FIG. 10 is a cross-sectional view that longitudinally bisects the strain relief boot of FIGS. 8 and 9.

### DETAILED DESCRIPTION

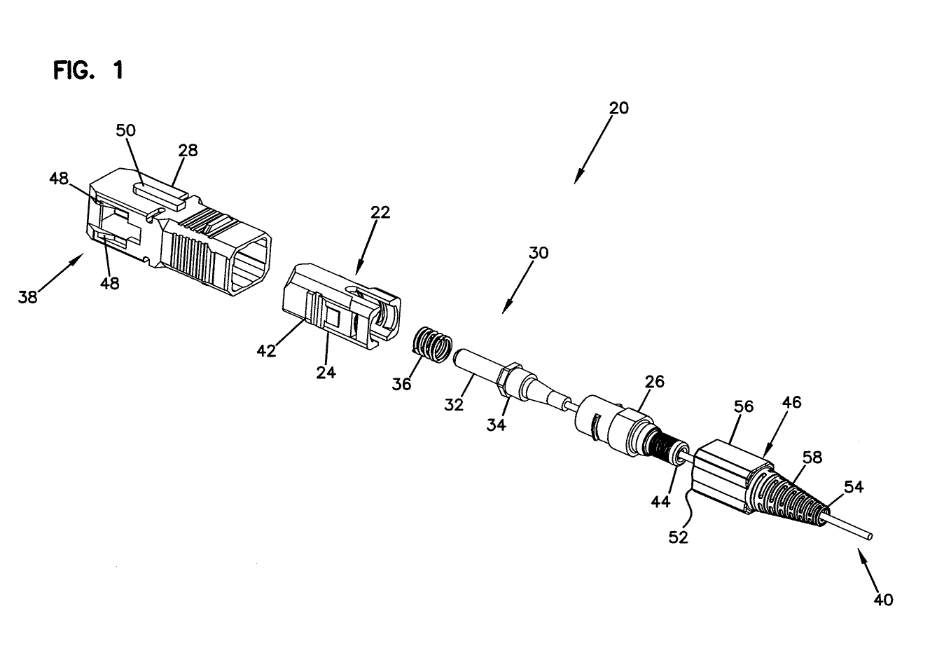

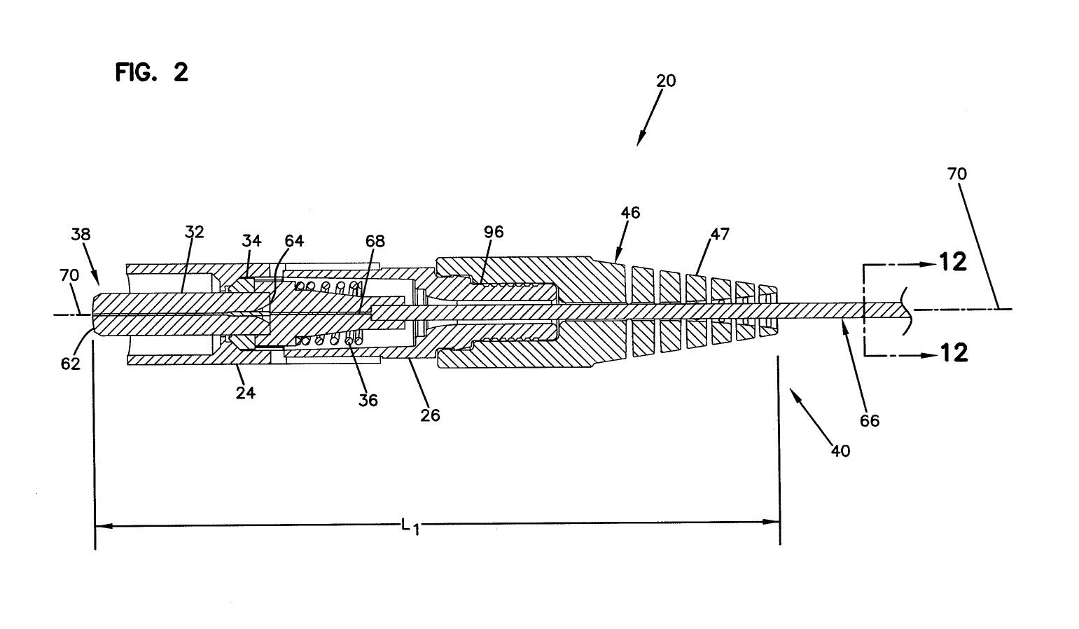

FIGS. 1 and 2 illustrate a first fiber optic connector 20 in accordance with the principles of the present disclosure. The first fiber optic connector 20 is depicted as a SC compatible connector.

The fiber optic connector 20 includes a connector housing 22 including a distal housing portion 24 that interconnects with a proximal housing portion 26 having a proximal end 44. The connector housing 22 can be referred to as a connector body. The fiber optic connector 20 also includes a release sleeve 28 that slidably mounts over the connector housing 22. The fiber optic connector 20 includes a ferrule assembly 30. The ferrule assembly 30 includes a ferrule 32, a hub 34 and a spring 36. The ferrule assembly 30 mounts at least partially within the connector housing 22. The fiber optic connector 20 has a total length L₁ that extends from a distal end 38 of the fiber optic connector 20 to a proximal end 40 of the fiber optic connector 20. The ferrule assembly 30 mounts adjacent the distal end 38 of the fiber optic connector 20. The proximal end 40 of the fiber optic connector 20 is configured to receive, anchor and provide strain relief/bend radius protection to a fiber optic cable 66. The fiber optic cable 66 can include a jacket surrounding at least one optical fiber 68. The fiber optic cable 66 can also include a strength layer 96 formed by a plurality of strength members (e.g., reinforcing fibers such as aramid yarn/Kevlar) positioned between the optical fiber 68 and the jacket. A distal end portion of the strength layer 96 can be crimped between a crimp sleeve and the exterior surface of the proximal end 44 of the proximal housing portion 26 so as to anchor the strength layer 96 to the connector housing 22. The optical fiber 68 can be routed through the total length L₁ of the fiber optic connector 20 and include a distal portion secured within the ferrule 32. The fiber optic connector 20 further includes a strain relief boot 46 mounted at the proximal end 40 of the fiber optic connector 20 for providing strain relief and bend radius protection to the optical fiber 68.

Referring to FIG. 2, the ferrule 32 of the ferrule assembly 30 includes a distal end 62 and a proximal end 64. The distal end 62 projects distally outwardly beyond a distal end of the connector housing 22 and the proximal end 64 is secured within the ferrule hub 34. When the connector housing 22 is assembled as shown at FIG. 2, the ferrule hub 34 and the spring 36 are captured between the distal housing portion 24 and the proximal housing portion 26 of the connector housing 22. As so configured, the spring 36 is configured to bias the ferrule 32 in a distal direction relative to the connector housing 22. When two of the fiber optic connectors 20 are interconnected, their ferrules 32 are forced to move in proximal directions relative to their respective connector housings 22 against the bias of their respective springs 36. The movement is along the central axes 70 of the mated fiber optic connectors 20.

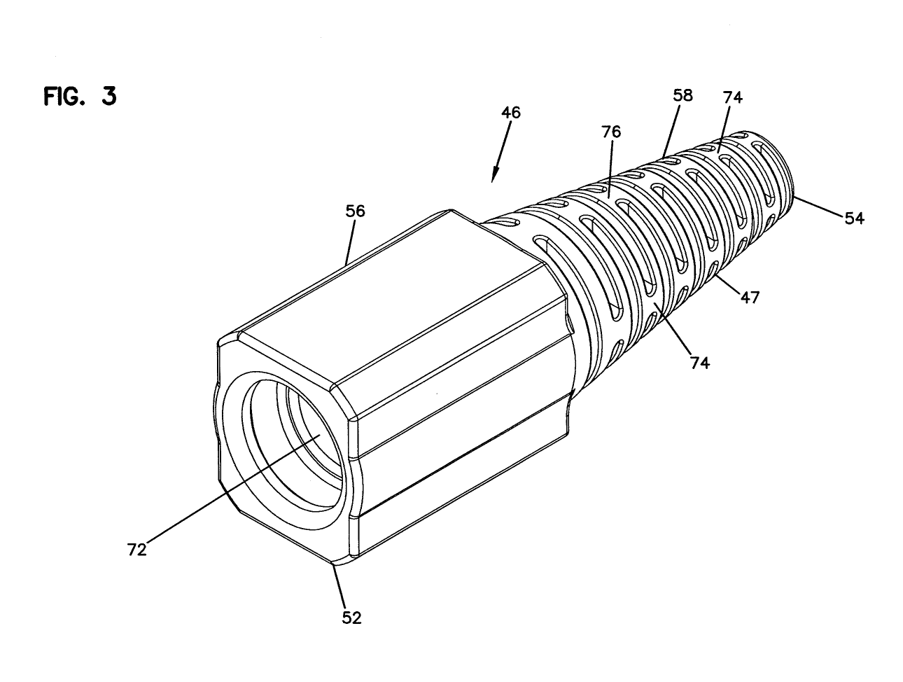

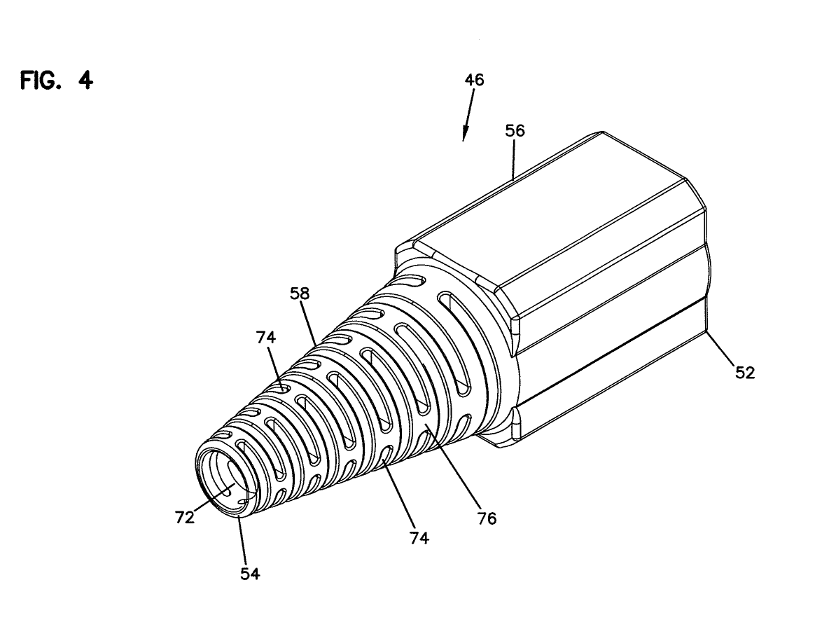

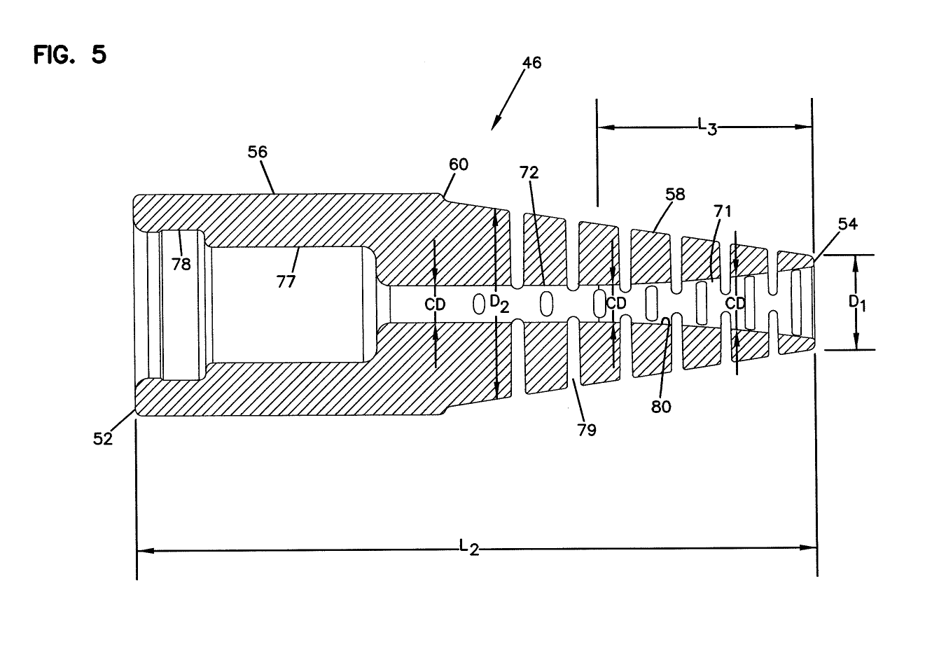

Referring to FIGS. 3-5, the strain relief boot 46 of the fiber optic connector 20 includes a distal end 52 and an opposite proximal end 54. The strain relief boot 46 includes an exterior surface 47 defining a tapered exterior shape that tapers inwardly toward the central longitudinal axis 70 as the tapered exterior shape extends in a proximal direction along the central longitudinal axis 70. The strain relief boot 46 defines an inner passage 72 that extends through the boot 46 from the proximal end 54 to the distal end 52. When the strain relief boot 46 is mounted on the connector housing 22, the inner passage 72 aligns with a central longitudinal axis 70 of the fiber optic connector 20. The strain relief boot 46 includes a connection portion 56 positioned adjacent the distal end 52 and a tapered, strain relief portion 58 positioned adjacent the proximal end 54. The exterior surface 47 of the strain relief portion 58 tapers radially inwards as the strain relief portion 58 extends in the proximal direction. In other examples, the strain relief boot 46 can include a transition portion located between the connection portion 56 and the tapered, strain relief portion 58. In this example, the connection portion 56 has a larger cross-dimension than a corresponding cross-dimension of the tapered, strain relief portion 58.

In this example, the connection portion 56 of the strain relief boot 46 has an outer shape that is generally rectangular when viewed in transverse cross-section. The connection portion 56 defines an enlarged region 78 of the inner passage 72. The enlarged region 78 is generally cylindrical and is configured to receive the proximal end 44 of the connector housing 22 when the strain relief boot 46 is mounted on the connector housing 22.

In this example, an intermediate region 77 of the inner passage 72 coincides generally with the connection portion 56 of the strain relief boot 46. The intermediate region 77 has a smaller cross-dimension than a corresponding cross-dimension of the enlarged region 78.

A strain relief region 80 of the inner passage 72 extends through the tapered, strain relief portion 58 of the strain relief boot 46. In this example, the strain relief region 80 defines a plurality of gradually increasing cross dimensions CD (e.g., inner diameter) as the strain relief region 80 of the inner passage 72 extends from the intermediate region 77 of the inner passage 72 to the proximal end 54 of the strain relief boot 46. In this example, the cross-dimensions CD of the strain relief region 80 of the inner passage 72 are configured to gradually flare out radially outwards as the inner passage 72 extends in a direction toward the proximal end 54 of the strain relief boot 46. The strain relief boot 46 includes an interior surface 71 defining an inner passage 72 (e.g., fiber passage) through which the optical fiber 68 is routed. The interior surface 71 of the strain relief boot 46 defining a flared interior shape co-extensive along the central longitudinal axis 70 with a least a portion of the tapered exterior shape. The flared interior shape of the inner passage 71 flaring outwardly from the central longitudinal axis 70 as the flared interior shape extends in the proximal direction along the central longitudinal axis 70. In one example, the cross-dimension CD is a diameter that is only slightly larger than 1.2 millimeters such that the fiber optic cable 66 can be inserted through the strain relief region 80 of the inner passage 72. The flared configuration of the inner passage 72 helps to provide bend radius protection to the optical fiber 68 routed to the first fiber optic connector 20.

The plurality of gradually increasing cross dimensions CD of the strain relief region 80 of the inner passage 72 can be less than 1.5 millimeters. The strain relief region 80 of the inner passage 72 has a flare length L₃ less than half a length L₂ of the strain relief boot 46. In other examples, the strain relief region 80 of the inner passage 72 has a flare length L₃ less than the length L₂ of the strain relief boot 46. In certain examples, the flare length L₃ is greater than ⅛, or 1/7, or ⅙, or ⅕, or ¼, or ⅓ of the length L₂ of the strain relief boot 46.

The strain relief boot 46 is preferably made of a molded plastic material having flexible characteristics. In some examples, the strain relief boot 46 is more flexible than the connector housing 22 (e.g., connector body). In other examples, the strain relief boot 46 could be made out of a material that has less flexible characteristics or is more rigid. In certain examples, the strain relief boot 46 is made of a rigid material and can be arranged and configured to have more flexibility than the connector housing 22 by having circumferential gaps 79 (e.g., slots) in the strain relief boot 46.

The tapered, strain relief portion 58 is formed by a plurality of rings 74 that are generally coaxially aligned with one another and centered about the central longitudinal axis 70. The flexibility of the strain relief boot 46 is enhanced at the tapered, strain relief portion 58 by the segmented configuration provided by the rings 74 connected by axial links 76. The tapered, strain relief portion 58 of the strain relief boot 46 is depicted as having a truncated conical configuration with a minor outer diameter D₁ positioned at the proximal end 54 of the strain relief boot 46 and a major outer diameter D₂ positioned adjacent the connection portion 56. The rings 74 are axially separated from one another by the circumferential gaps 79 (e.g., slots). The rings 74 are interconnected to one another by an arrangement of the axial links 76 (e.g., struts, connection points, etc.) that extend across the circumferential gaps 79. In this example, the strain relief portion 58 of the strain relief boot 46 is configured to gradually taper in a direction toward the proximal end 54 of the strain relief boot 46. The taper is in a direction opposite the flare of the strain relief region 80 of the inner passage 72. The taper has a length L₅ less than the length L₂ of the boot 46. In some examples, the strain relief portion 58 has a taper length L₅ greater than the flare length L₄ of the strain relief region 80 of the inner passage 72. In other examples, of the strain relief region 80 the inner passage 72 has a flare length L₄ greater than at least half of the taper length L₅ of the strain relief portion 58 of the strain relief boot 46. In certain examples, the flare length L₄ of the strain relief region 80 of the inner passage 72 is less than the taper length L₅ of the strain relief portion 58 of the strain relief boot 46.

In some examples, a transition portion 60 (e.g., a shoulder) is positioned between the connection portion 56 and the tapered, strain relief portion 58. An outer surface of the transition portion 60 provides a gradual decrease in cross-dimension as the outer surface extends from the tapered, strain relief portion 58 to the connection portion 56. The outer surface of the transition portion 60 can be manually pushed to facilitate inserting the connection portion 56 over the proximal end 44 of the connector housing 22 during assembly of the fiber optic connector 20.

In the depicted example of FIG. 1, the release sleeve 28 is shown as a conventional SC release sleeve. When the release sleeve 28 is mounted on the connector housing 22, the release sleeve 28 is free to slide back-and-forth in distal and proximal directions relative to the connector housing 22 along the central longitudinal axis 70 of the fiber optic connector 20.

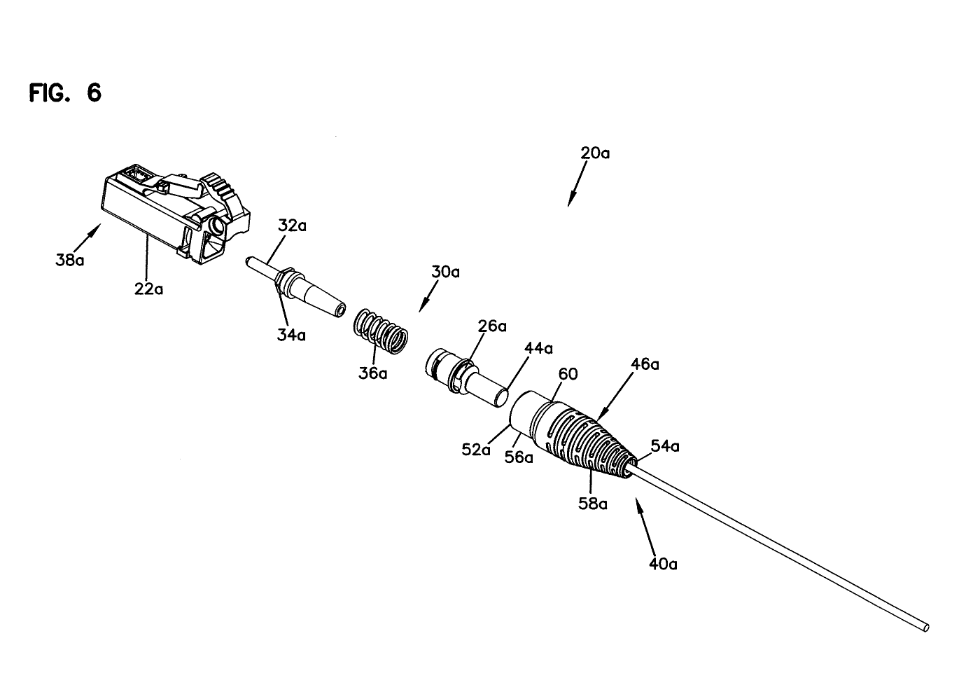

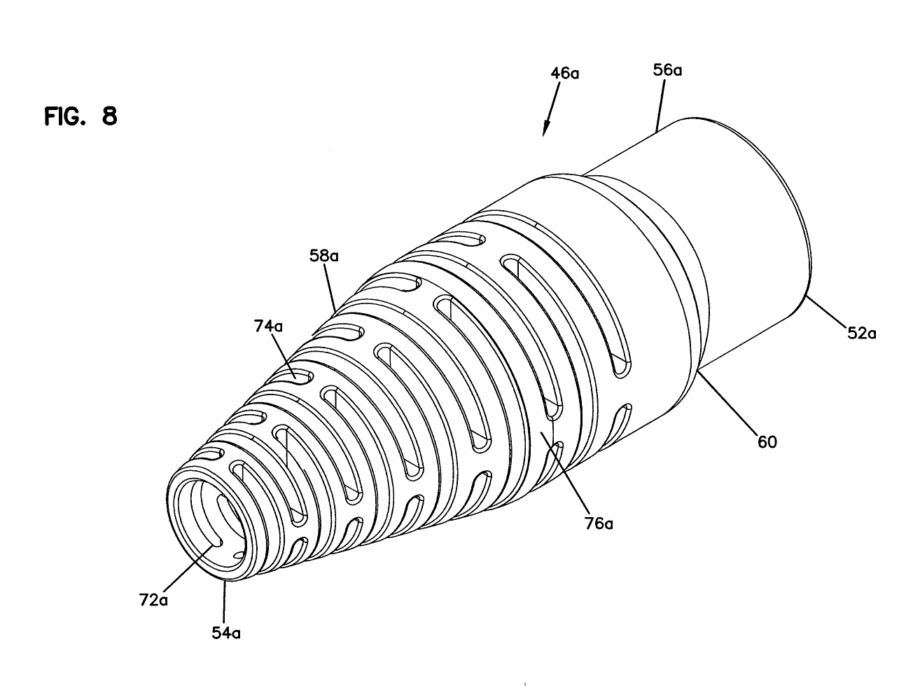

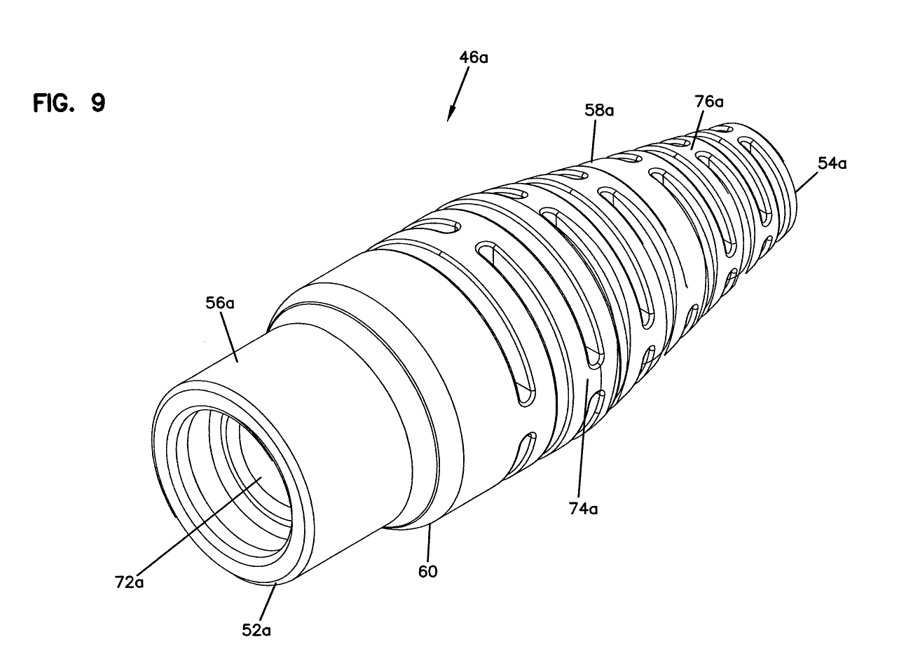

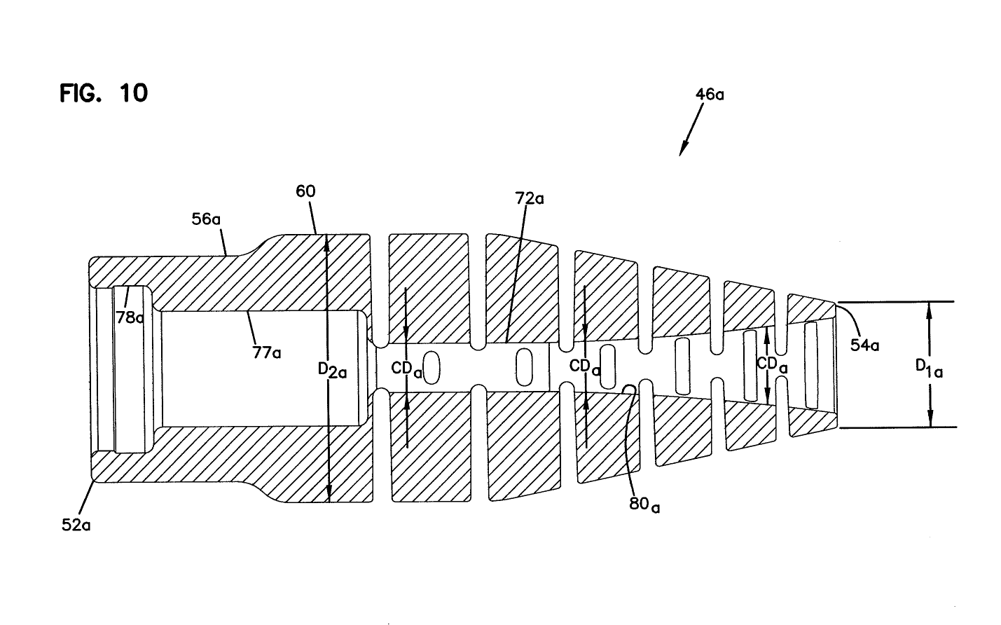

Referring to FIGS. 6-10, a second fiber optic connector 20a is shown with a boot 46a. The second fiber optic connector 20a is depicted as an LC compatible connector. The second fiber optic connector 20a includes a connector housing 22a. The connector housing 22a can be referred to as a connector body. The second fiber optic connector 20a includes a rear connector housing 26a that interconnects with the connector housing 22a. The second fiber optic connector 20a also includes a ferrule assembly 30a. The ferrule assembly 30a includes a ferrule 32a, a hub 34a and a spring 36a. The ferrule assembly 30a mounts at least partially within the connector housing 22a. The second fiber optic connector 20a further includes a strain relief boot 46a mounted at the proximal end 40a of the second fiber optic connector 20a for providing strain relief and bend radius protection to the optical fiber 68a. The strain relief boot 46a may be used with connectors other than the LC compatible connectors.

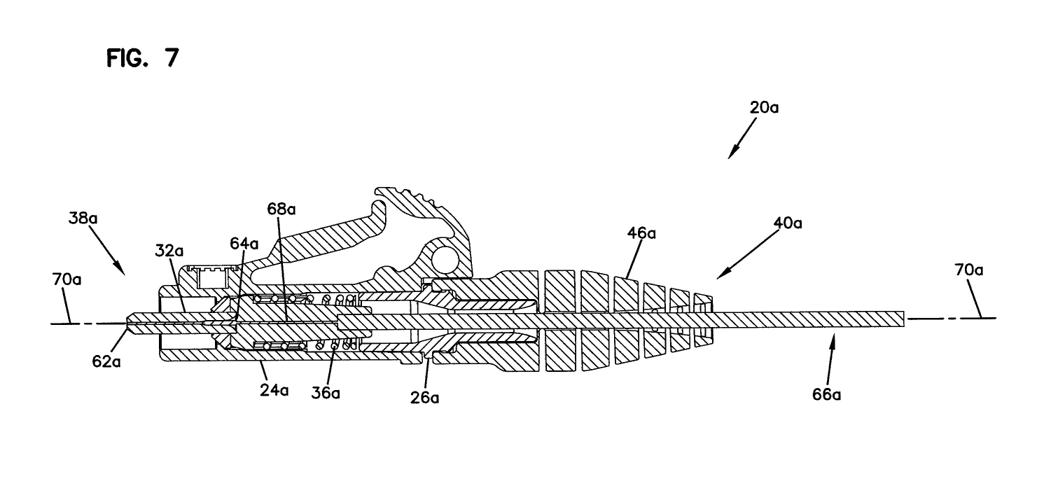

Referring to FIGS. 7-10, the strain relief boot 46a of the second optic connector 20a includes a distal end 52a and an opposite proximal end 54a. The strain relief boot 46a defines an inner passage 72a that extends through the boot 46a from the proximal end 54a to the distal end 52a. When the strain relief boot 46a is mounted on the connector housing 22a, the inner passage 72a aligns with a central longitudinal axis 70a of the second fiber optic connector 20a. The strain relief boot 46a includes a connection portion 56a positioned adjacent the distal end 52a and a tapered, strain relief portion 58a positioned adjacent the proximal end 54a. In this example, the strain relief boot 46a includes a transition portion 60 located between the connection portion 56a and the tapered, strain relief portion 58a. An outer surface of the transition portion 60 provides a gradual decrease in cross-dimension as the outer surface extends from the tapered, strain relief portion 58a to the connection portion 56a. The outer surface of the transition portion 60 can be manually pushed to facilitate inserting the connection portion 56a over the proximal end 44a of the connector housing 22a during assembly of the second fiber optic connector 20a.

In this example, the connection portion 56a has a larger cross-dimension than a corresponding cross-dimension of the tapered, strain relief portion 58a. As shown, the connection portion 56a of the strain relief boot 46a has an outer shape that is generally circular when viewed in transverse cross-section. It is understood that the connection portion 56a may include other shapes. The connection portion 56a defines an enlarged region 78a of the inner passage 72a. The enlarged region 78a is generally cylindrical and is configured to receive the proximal end 44a of the connector housing 22a when the boot 46a is mounted on the connector housing 22a.

In this example, an intermediate region 77a of the inner passage 72a coincides generally with the transition portion 60 of the boot 46a. The intermediate region 77a has a smaller cross-dimension than a corresponding cross-dimension of the enlarged region 78a.

A strain relief region 80a of the inner passage 72a extends through the tapered, strain relief portion 58a of the boot 46a. In this example, the strain relief region 80a defines a plurality of gradually increasing cross dimensions CDa (e.g., inner diameter) as the strain relief region 80a of the inner passage 72a extends from the intermediate region 77a of the inner passage 72a to the proximal end 54a of the boot 46a. In this example, the cross-dimensions CDa of the strain relief region 80a of the inner passage 72a are configured to gradually flare out in a direction toward the proximal end 54a of the boot 46a. In one example, the cross-dimension CDa is a diameter that is only slightly larger than 1.2 millimeters such that the fiber optic cable 66a can be inserted through the strain relief region 80a of the inner passage 72a. The flare configuration of the inner passage 72a helps to provide bend radius protection to the optical fiber 68a routed to the second fiber optic connector 20a.

The plurality of gradually increasing cross dimensions CDa of the strain relief region 80a of the inner passage 72a can be less than 1.5 millimeters. The strain relief boot 46a is preferably made of a molded plastic material having flexible characteristics. The tapered, strain relief portion 58a is formed by a plurality of rings 74a that are generally coaxially aligned with one another and centered about the central longitudinal axis 70a. The flexibility of the boot 46a is enhanced at the tapered, strain relief portion 58a by the segmented configuration provided by the rings 74a connected by axial links 76a. The tapered, strain relief portion 58a of the boot 46a is depicted as having a truncated conical configuration with a minor outer diameter D₁ₐ positioned at the proximal end 54a of the boot 46a and a major outer diameter D₂ₐ positioned adjacent the connection portion 56a. The rings 74a are axially separated from one another by circumferential gaps 79a (e.g., slots). The rings 74a are interconnected to one another by an arrangement of the axial links 76a (e.g., struts, connection points, etc.) that extend across the circumferential gaps 79a.

In this example, the strain relief portion 58a of the boot 46a is configured to gradually taper in a direction toward the proximal end 54a of the boot 46a. The taper is in a direction opposite the flare of the strain relief region 80a of the inner passage 72a.

From the forgoing detailed description, it will be evident that modifications and variations can be made without departing from the spirit and scope of the disclosure.

What is claimed is:

1. A fiber optic connector comprising:
a connector body including a distal end and a proximal end, the distal end forming a plug end of the connector body;
an optical fiber routed through the connector body, the optical fiber having an end face accessible at the plug end of the connector body; and
a strain relief boot that mounts at the proximal end of the connector body, the strain relief boot defining a longitudinal axis that extends through the strain relief boot between distal and proximal ends of strain relief boot, the strain relief boot including an interior surface defining a fiber passage through which the optical fiber is routed, the fiber passage extending along the longitudinal axis of the boot, the strain relief boot including an exterior surface defining a tapered exterior shape that tapers inwardly toward the longitudinal axis as the tapered exterior shape extends in a proximal direction along the longitudinal axis, the interior surface of the strain relief boot defining a flared interior shape co-extensive along the longitudinal axis with at least a portion of the tapered exterior shape, the flared interior shape of the fiber passage flaring outwardly from the longitudinal axis as the flared interior shape extends in the proximal direction along the longitudinal axis.

2. The fiber optic connector of claim 1, wherein the flared interior shape and the tapered exterior shape are positioned adjacent the proximal end of the boot.

3. The fiber optic connector of claim 2, wherein the flared interior shape extends along the longitudinal axis of the strain relief boot for at least ⅛ of a total length of the strain relief boot.

4. The fiber optic connector of claim 2, wherein the flared interior shape and the tapered exterior shape extend coextensively along the longitudinal axis of the strain relief boot for at least ¼ of a total length of the strain relief boot.

5. The fiber optic connector of claim 1, wherein the strain relief boot is more flexible than the connector body.

6. The fiber optic connector of claim 1, wherein the fiber optic connector has a total length, and a length of the strain relief boot is less than half the total length of the fiber optic connector.

7. The fiber optic connector of claim 1, wherein a length of the strain relief boot is less than one inch.

8. The fiber optic connector of claim 1, wherein a portion of the strain relief boot that projects proximally beyond the connector housing has a length less than 0.75 inches.

9. The fiber optic connector of claim 1, wherein the tapered exterior shape of the strain relief boot has a taper length less than a length of the strain relief boot.

10. The fiber optic connector of claim 1, wherein the flared interior shape of the fiber passage has a flare length less than a length of the strain relief boot.

11. The fiber optic connector of claim 1, wherein the tapered exterior shape of the strain relief boot has a taper length greater than a flare length of the flared interior shape of the fiber passage.

12. The fiber optic connector of claim 1, wherein the flared interior shape of the fiber passage has a flare length greater than at least half of a taper length of the tapered exterior shape of the strain relief boot.

13. The fiber optic connector of claim 1, wherein the flared interior shape of the fiber passage has a flare length less than a taper length of the tapered exterior shape of the strain relief boot.

14. The fiber optic connector of claim 7, wherein a flare length of the flared interior shape of the fiber passage is greater than about ⅛ of the length of the strain relief boot.

15. The fiber optic connector of claim 14, wherein the flare length of the flared interior shape of the fiber passage is greater than ¼ of the length of the strain relief boot.
